(19) United States
(12) Patent Application Publication
(10) Pub. No.: US 2008/0034066 A1
(43) Pub. Date: Feb. 7, 2008

(54) Method for distribution of music

(76) Inventors: Michael Shamus, Alpharetta, GA (US); Jeremiah Edmond, Atlanta, GA (US); Daniel Hannon, Duluth, GA (US)

Correspondence Address: DEVINE, MILLIMET & BRANCH, P.A., 111 AMHERST STREET, BOX 719, MANCHESTER, NH, 03105, US

(21) Appl. No.: 11/890,261

(22) Filed: Aug. 3, 2007

Related U.S. Application Data
(60) Provisional application No. 60/835,323, filed on Aug. 3, 2006.

(51) Int. Cl. G06F 15/16

(52) U.S. Cl. 709/219

(57) ABSTRACT

A method for distributing music of multiple artists from a website. Each artist uploads music to a website and sells access cards to consumers allowing the consumers to access his music and the music of one or more other artists who have uploaded music to the website.

### CROSS REFERENCE TO RELATED APPLICATIONS

The present invention claims the benefit of co-pending U.S. Provisional Patent Application Ser. No. 60/835,323 filed on Aug. 3, 2006, which is fully incorporated herein by reference.

### TECHNICAL FIELD

The present invention relates to the sale and distribution of music. More specifically, it relates to a method that allows consumers to purchase from an artist the means to download music of the artist and of other artists from a website.

### BACKGROUND OF THE INVENTION

The goal of an artist is to have as many consumers as possible listen to and purchase his music. Typically, the method for an artist to do so involves the following steps: writing songs, forming a band, practicing, saving money to record a demonstration compact disc (“CD”), booking engagements, playing at engagements, selling CDs to consumers at engagements, being noticed, and being signed to a record label. The step of selling CDs is, perhaps, the most crucial. It both generates revenue to cover the artist's living expenses and it places his music into the hands of an increasing number of people. An artist may, typically, play 4-8 engagements per month and sell 5-10 CDs at each engagement, for total sales in the range of 20-80 CDs per month.

The present invention is a method that allows consumers to purchase music, which term is to be understood to include an audio component, such as songs, instrumental music or voice recordings, and a video component, such as pictures, films, or text or both. It allows consumers to purchase from an artist the means to download the artist's, and other artists, music from a website. The consumer can do so more easily and cheaply, and with more choice and control than purchasing CDs. Instead of an artist selling CDs, he sells access cards (“cards”). A card is typically credit card sized with the artist's artwork (similar to the artwork on the cover of a CD case) on at least one side of the card. A card contains information about, and instructions for the use of, the website; the number of songs that it allows its holder to download; and a unique identifier number.

It should be noted that there are “online music stores” (e.g. iTunes, CD Baby and Audio Lunch Box) that sell CDs or individual songs for about $0.99 each. There are also websites (e.g. MySpace or PureVolume) at which artists can upload their music to be available for free to consumers. These websites do not, however, offer artists a method of showcasing their music and generating revenue by selling cards instead of CDs at concerts.

### SUMMARY OF THE INVENTION

The present invention is a method of distributing music of multiple artists. It involves creating a website and allowing each one of multiple artists to upload music to a separate page of the website. Access cards are then distributed to one or more of the multiple artists who have uploaded music. The access cards allow access to the website.

Each of the artists to whom access cards are distributed then distributes access cards to consumers. Each of the consumers to whom an access card is distributed can use the access card to download music from the artist that distributed the access card to him or from one or more other artists who have uploaded music to the website.

### BRIEF DESCRIPTION OF THE DRAWINGS

These and other features and advantages of the present invention will be better understood by reading the following detailed description, taken together with the drawings wherein preferred embodiments are shown as follows:

FIG. 1 shows a flow-chart of a preferred embodiment of the method of the present invention.

### DETAILED DESCRIPTION OF PREFERRED EMBODIMENTS

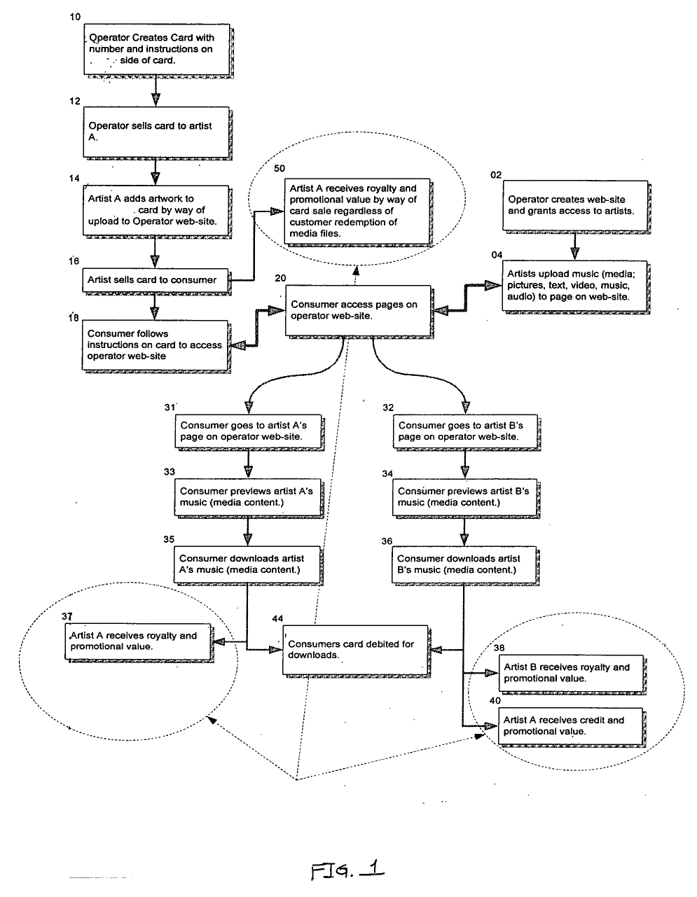

A flow-chart of a preferred embodiment of the method of the present invention is shown in FIG. 1. In this embodiment, an operator creates a website and grants multiple artists access to the website 02 without charge. Each artist may then upload music 04 to a separate page on the website. An artist will have control over his page to add to or change it at any time, and from time to time, without assistance or intervention from the operator. For example, the artist may include in the text on his page a calendar of his upcoming engagements.

Concurrently, the operator creates cards 10 for each artist who has created a page on the website. Each card contains a unique identifier number, the amount of music that it allows its holder to download, and instructions for accessing the website and downloading music by entering the unique identifier number as a pass code at the website. A card is, in a preferred embodiment, a credit card sized piece of plastic with the unique identifier number printed on it. However, the term card is to be understood to include any object with a unique identifier number, printed on it, contained in a bar code on it, contained in a RFID on it, or otherwise incorporated in or on it. It is also to be understood to include a virtual card, a card that is displayed on-line with a unique identifier number. The operator then sells or otherwise distributes the cards to the artist 12.

The artist can add artwork 14 (similar to the artwork on the cover of a CD case) to one or more sides of each card. The card can be one of a numbered, limited edition set that is collectible. The artist no longer needs to spend thousands of dollars to buy CDs in bulk to lower the cost of an individual CD to a few dollars. The cards will be offered in various quantities, requiring only a small investment compared to purchasing CDs in volume.

An artist then sells the cards distributed to him, typically at an engagement at which he is performing or his work is displayed (but he is not necessarily so limited), to consumers 16. As the artist is already used to selling CDs at such engagements, the concept of selling his music at an engagement is not new. Typically, the artist may sell the card, which may be used for a specified number of music downloads from the website, to the consumer for a specified price. The card may have been purchased from the operator at a lower price that allows a significant profit for the artist. At this point, the artist receives his royalty 50, which is the difference between the price for which the operator sells the card and the price for which the artist sells the card. The royalty the artist receives does not change regardless of whether the card is used by a consumer, as described in more detail below, to download any music.

The consumer then follows the instructions on the card to access the website 18. He logs in at the website with his unique identifier number from the card to access the pages on the website 20. The consumer is automatically directed to the page of the artist who sold him the card 31. The consumer may then preview the music on the page 33, which may include a preview of audio, video components or both. The preview may include either unlimited access or limited access to various components. It may include access for an unlimited period of time to text on the page; access for a limited period of time, for example 60 seconds, to audio components on the page; and access at lower resolution to other video components on the page. This feature is not available to a consumer purchasing a CD at an engagement.

The consumer may then download that portion of the music on the page that he has chosen 35. The file downloaded will, typically, but not necessarily, be an audio component in an MP3 format, but may be in any one of a number of formats known to those skilled in the art. The download may comprise wireless or wired transmission of the downloaded file to a storage medium that may be a stand alone medium or one incorporated in a card or a media player. The record of the card use on the website is automatically debited one or more downloads 44 depending on the specific music downloaded in addition, the artist receives a further agreed-upon royalty 37 for the music download, which further agreed-upon royalty is paid by the operator, typically out of the proceeds of the sales of cards to artists.

While a consumer is automatically directed to the page of the artist who sold him a card, the consumer has access to each artist's page on the website. Thus, significant promotional value is provided to all participating artists because each consumer has access to the pages of all the artists. The consumer may at any time, and from time to time, go to another artist's page 32. This gives the consumer choice and control over the music he purchases.

For example, a consumer may go to the page of an artist other than the artist who sold him a card. The consumer may then preview the music on this artist's page 34 and download that portion of the music he chooses 36. The record of the card use on the website is automatically debited one or more downloads 44. In this case, the artist whose music is downloaded receives a further agreed-upon royalty 38, and the artist who sold the card to the consumer receives a credit 40. The credit may be additional cards at no charge to sell to consumers. In addition, consumers may buy additional cards directly from site using a credit card or some other kind of online payment method. These cards can be used for any music on the site and artists will be paid the further agreed-upon royalties for any downloads.

In another embodiment, a consumer may have access only to the pages of artists who agree to such access. The consumer may go to the page of such an artist and download that portion of the music that he chooses. In this case, the artist whose music is downloaded may not receive any further agreed-upon royalty, having agreed to allow consumers to download music at no cost. In yet another embodiment, a consumer may have access only to the page of the artist who sold him a card.

As a further example, an artist may potentially sell many more cards for $5.00 each than CDs for $10.00 each. The cards are a much better value than a CD as each card may offer 20 downloads for one-half the price of a CD.

It should be noted that an artist may create a page on the website at no cost but never purchase or otherwise receive, for resale or other distribution, any cards. The artist will still have his music exposed on the website to many consumers. Consumers who have purchased cards from other artists will have access to this artist's page. Moreover, consumers may download his music and he will receive a further agreed-upon royalty.

While the principles of the present invention have been described herein, it is to be understood by those skilled in the art that this description is made only by way of example and not as a limitation as to the scope of the present invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A method of distributing music of multiple artists comprising,
creating a website and allowing each one of multiple artists to upload music to a separate page of the website,
distributing to one or more of the multiple artists who have uploaded music access cards allowing access to the website,
allowing each of the artists to whom access cards are distributed to distribute the access cards to consumers,
allowing a consumer to whom an access card is distributed to use the access card to download music from the artist that distributed the access card to him and from one or more other artists who have uploaded music.

2. The method of claim 1 further comprising allowing any one of the artists who have uploaded music to a separate page to supplement, delete or revise the music uploaded to his page.

3. The method of claim 1 further comprising charging each artist to whom access cards are distributed a fee based on the number of access cards so distributed.

4. The method of claim 1 further comprising debiting a record of the use of an access card when the access card is used to download music.

5. The method of claim 1 further comprising paying an artist an agreed-upon royalty when an access card distributed by the artist is used to download music from the artist's page of the website.

6. The method of claim 1 further comprising paying an artist an agreed-upon royalty when an access card distributed by another artist is used to download music from the artist's page of the website.

7. The method of claim 1 further comprising crediting an artist when an access card distributed by the artist is used to download music from another artist's page of the website.

8. The method of claim 1 further comprising distributing access cards directly to consumers.

9. The method of claim 1 further comprising allowing consumers to whom access cards are distributed to preview music of one or more of the artists who have uploaded music.

10. A method of distributing music of multiple artists comprising,
creating a website and allowing each one of multiple artists to upload music to a separate page of the website,
distributing to one or more of the multiple artists who have uploaded music access cards allowing access to the website,
allowing each of the artists to whom access cards are distributed to distribute the access cards to consumers,
allowing a consumer to whom an access card is distributed to use the access card to download music from the artist that distributed the access card to him.
